(19) United States
(12) Patent Application Publication
(10) Pub. No.: US 2026/0360767 A1
(43) Pub. Date: Nov. 12, 2026

(54) CATALYST LAYER AND METHOD FOR MANUFACTURING SAME, AND MEMBRANE-ELECTRODE ASSEMBLY AND METHOD FOR MANUFACTURING SAME

(71) Applicant: KOLON INDUSTRIES, INC., Seoul (KR)

(72) Inventors: Jung Ho KIM, Seoul (KR); Jun Houng KIM, Seoul (KR); Kah Young SONG, Seoul (KR); Nak Won KONG, Seoul (KR); Eun Su LEE, Seoul (KR); Hyeong Su KIM, Seoul (KR); Hyeong Sik NAM, Seoul (KR); Chan Mi PARK, Seoul (KR); Ju Sung LEE, Seoul (KR)

(21) Appl. No.: 19/140,337

(22) PCT Filed: Mar. 31, 2023
(86) PCT No.: PCT/KR2023/004410

§ 371 Date: Jun. 17, 2025

(30) Foreign Application Priority Data
Apr. 14, 2022 (KR) 10-2022-0046185
Mar. 28, 2023 (KR) 10-2023-0040658

(51) Int. Cl. H01M 4/88; H01M 8/10; H01M 8/1004

(52) U.S. Cl. CPC H01M 4/8875; H01M 4/8828; H01M 8/1004; H01M 2008/1095

(57) ABSTRACT

Provided is a catalyst layer which improves the performance and durability of a membrane-electrode assembly. An aspect of the present disclosure provides a catalyst layer which has a flexural modulus of 50 to 400 MPa and a flexural strength of 0.3 to 10 MPa.

### TECHNICAL FIELD

The present disclosure relates to a catalyst layer satisfying mechanical properties and a method for manufacturing the same, and more particularly, to a membrane-electrode assembly including a catalyst layer satisfying specific mechanical properties and a method for manufacturing the same.

### BACKGROUND ART

Recently, due to environmental pollution caused by excessive use of fossil fuels and a sudden rise in oil prices, an interest in fuel cells that emit less environmental pollutants and have high energy efficiency has increased. The fuel cell does not convert chemical energy of a raw material into mechanical energy, and directly converts the chemical energy of the raw material into electrical energy using an electrochemical conversion method. The fuel cell uses a principle opposite to electrolysis of water. That is, when water is electrolyzed, the water is decomposed into hydrogen and oxygen through external electricity, whereas the fuel cell generates electricity by electrochemically reacting hydrogen and oxygen with each other. This is expressed as the following Formulas (1) and (2), which are chemical reaction formulas.

Anode: H₂→2H⁺+2e⁻ Formula (1)

A reaction at an anode is an oxidation reaction, the oxidation of hydrogen is facilitated by a platinum catalyst, an anode catalyst of a low-temperature fuel cell should oxidize hydrogen, and in an actual system, fuel may contain CO, S, NH₃, or the like, rather than pure hydrogen. Among them, CO is a major toxic material in the low-temperature fuel cell and is easily adsorbed on the platinum catalyst. Carbon monoxide adsorbed on the platinum catalyst is attached to an active site of the platinum catalyst, thus reducing the reaction area with hydrogen and weakening the platinum catalyst. In order to reduce damage caused by carbon monoxide, CO should be oxidized to CO₂.

Cathode: ½O₂+2H⁺+2e⁻→H₂O Formula (2)

A reaction at a cathode is a reduction reaction, and oxygen passes through the electrolyte to the anode and recombines with hydrogen at the anode to generate water. The cathode has been widely studied due to the excellence of a platinum-based catalyst, and the material is the best in the reduction action of oxygen. In order to compensate for low reactivity caused by a low-temperature operation, the amount of metal added for an oxidation catalyst is high and such a type of fuel cell uses air as cathode gas. Here, the partial pressure of oxygen is lower than that of pure oxygen, and thus, the activity of the reaction is reduced. The porosity of the cathode layer may be optimized by adding a pore-forming material.

There are various types of fuel cells such as polymer electrolyte membrane fuel cells (PEMFC), solid oxide fuel cells (SOFC), and molten carbonate fuel cells (MCFC), depending on fuels or materials. A fuel cell power generation device includes a fuel reformer that chemically converts a general fuel (e.g., liquefied petroleum gas (LPG), liquefied natural gas (LNG), methane, coal gas methanol, etc.) containing hydrogen into gas containing a lot of hydrogen required by a fuel cell, a stack that generates direct current (DC) electricity, water, and heat, which is a byproduct, from hydrogen entering from the fuel reformer and oxygen in the air, and an inverter that converts DC power from the fuel cell into alternating current (AC) power. The most important portion of the stack is a membrane-electrode assembly (MEA). The membrane-electrode assembly is a film-shaped assembly serving to induce a chemical reaction between oxygen and hydrogen to generate electrical energy. Hydrogen and oxygen supplied to the fuel cell become ions by releasing electrons at the cathode and the anode, respectively, and the released electrons escape to the outside to become a current. Such a reaction occurs in the membrane-electrode assembly. The membrane-electrode assembly includes an electrolyte membrane, an anode, and a cathode.

Meanwhile, a catalyst layer constituting a polymer electrolyte membrane fuel cell is manufactured by forming a catalyst layer using a catalyst slurry obtained by mixing catalyst particles and a polymer electrolyte (binder) with each other in a solvent and drying the same. Conventionally, after the catalyst layer or the membrane-electrode assembly is manufactured, only mechanical properties such as a Young's modulus or a tensile strength were measured and utilized only as reference data. Factors having an influence on the mechanical strength of the catalyst layer or the membrane-electrode assembly include the types and contents of materials used, a manufacturing method, and the like. When the mechanical strength of the catalyst layer or the membrane-electrode assembly is not at an appropriate level, the following problems may occur.

1) Since the rate of deformation by dry-wet cycles is significantly greater in a polymer electrolyte membrane than in the catalyst layer, the dry-wet cycle caused by the operation of the fuel cell results in deformation of the polymer electrolyte membrane, which in turn causes deformation of the catalyst layer, such as cracking and peeling.

2) when water in the catalyst layer freezes under a low-temperature condition, deformation of the catalyst layer is caused due to volume expansion caused by the phase change of the water. As a result, the deformed catalyst layer is isolated from the reaction system of the fuel cell, so that the amount of catalyst that may contribute to power generation is reduced and the power generation function is significantly reduced.

3) There is a method for increasing the amount of ionomer included in the catalyst layer in order to improve the strength of the catalyst layer, but power generation performance may be reduced due to a reduction in drainage and gas diffusion.

Accordingly, there is a need for improvements in increasing the operation efficiency of the fuel cell and increasing the durability by securing the mechanical properties of the catalyst layer.

### DISCLOSURE

### Technical Problem

The present disclosure has been made in order to solve the above-described problems, and an object of the present disclosure is to predict performance and durability by measuring the mechanical properties of a catalyst layer or a membrane-electrode assembly and to provide a membrane-electrode assembly having improved performance and durability including a catalyst layer satisfying specific mechanical properties, and a method for manufacturing the same.

### Technical Solution

To achieve the above object, according to a first aspect of the present disclosure, there is provide a catalyst layer having a flexural modulus of 50 to 400 MPa and a flexural strength of 0.3 to 10 MPa. Here, the flexural strength is a value obtained by measuring a maximum force applied until a catalyst layer sample is permanently deformed, using an Instron 5966 instrument.

According to a second aspect of the present disclosure, in the first aspect, the catalyst layer may be a free-standing catalyst layer.

According to a third aspect of the present disclosure, in the second aspect, the Young's modulus of the free-standing catalyst layer may be 150 to 500 MPa.

According to a fourth aspect of the present disclosure, in the second or third aspect, the tensile strength of the free-standing catalyst layer may be 1 to 30 MPa.

According to a fifth aspect of the present disclosure, in any one of the second to fourth aspects, the indentation hardness of the free-standing catalyst layer may be 0.05 to 3.0 MPa.

According to a sixth aspect of the present disclosure, in any one of the second to fifth aspects, the density of the free-standing catalyst layer may be 0.1 to 2.0 g/cm³.

According to a seventh aspect of the present disclosure, in any one of the second to sixth aspects, the free-standing catalyst layer may include: a sub-catalyst layer; and an interfacial bonding layer (IBL) disposed on at least one surface of the sub-catalyst layer.

According to an eighth aspect of the present disclosure, in any one of the second to seventh aspects, the thickness of the interfacial bonding layer may be 0.1 to 1.5 μm.

According to a ninth aspect of the present disclosure, there is provided a method for manufacturing a catalyst layer comprising: a first step of preparing an electrode slurry including a catalyst and an ionomer; a second step of forming a sub-catalyst layer by coating and then drying the electrode slurry on a substrate; a third step of forming an interfacial bonding layer by coating and then drying an ionomer solution on one surface of the sub-catalyst layer; and a fourth step of separating the catalyst layer from the substrate by immersing and then leaving a resultant of the third step in water.

According to a tenth aspect of the present disclosure, there is provided a membrane-electrode assembly including the catalyst layer according to any one of the first to eighth aspects, and having a flexural modulus of 450 to 1,000 MPa, and a flexural strength of 12 to 80 MPa.

According to an eleventh aspect of the present disclosure, in the tenth aspect, the Young's modulus of the membrane-electrode assembly may be 650 to 1,600 MPa.

According to a twelfth aspect of the present disclosure, in the tenth or eleventh aspect, the tensile strength of the membrane-electrode assembly may be 35 to 90 MPa.

According to a thirteenth aspect of the present disclosure, in any one of the tenth to twelfth aspects, the indentation hardness of the membrane-electrode assembly may be 2.0 to 9.0 MPa.

According to a fourteenth aspect of the present disclosure, there is provided a method for manufacturing a membrane-electrode assembly, comprising a step of bonding the catalyst layer according to any one of the first to eighth aspects and an electrolyte membrane to each other.

According to a fifteenth aspect of the present disclosure, in any one of the tenth to thirteenth aspects, the electrolyte membrane and the interfacial bonding layer may be in contact with each other.

### Advantageous Effects

As described above, according to the present disclosure, by providing a membrane-electrode assembly that satisfies specific mechanical properties and includes a catalyst layer satisfying mechanical properties, it is possible to improve the mechanical properties of the membrane-electrode assembly.

In addition, it is possible to provide new parameters for the membrane-electrode assembly including the catalyst layer satisfying the mechanical properties and a free-standing catalyst layer.

Further, it is possible to develop and utilize a catalyst layer satisfying mechanical properties and a membrane-electrode assembly including the catalyst layer through characterization of the mechanical properties.

Furthermore, it is possible to predict and utilize performance and durability by measuring the mechanical properties of the catalyst layer or the membrane-electrode assembly.

### BRIEF DESCRIPTION OF DRAWINGS

FIG. 1 shows the size of a dog bone-shaped specimen of a catalyst-coated membrane (CCM) according to Experimental Example 1 of the present disclosure.

FIG. 2a is an image of free-standing catalyst layers according to Experimental Examples 2 and 3 of the present disclosure before the Young's modulus and the tensile strength are measured, and FIG. 2b is an image of the free-standing catalyst layers according to Experimental Examples 2 and 3 of the present disclosure after the Young's modulus and the tensile strength are measured.

FIG. 3a is an image of membrane-electrode assemblies according to Experimental Examples 2 and 3 of the present disclosure before the Young's modulus and the tensile strength are measured, and FIG. 3b is an image of the membrane-electrode assemblies according to Experimental Examples 2 and 3 of the present disclosure after the Young's modulus and the tensile strength are measured.

### MODE FOR DISCLOSURE

In the accompanying drawings, the same reference numerals denote the same components, and sizes of the respective components may be exaggerated for the purpose of clarity and convenience of explanation. Meanwhile, embodiments to be described later are merely examples, and various modifications may be made from these embodiments. Hereinafter, terms are used only to distinguish one component from another component. Singular forms include plural forms unless the context clearly indicates otherwise. In addition, unless explicitly described to the contrary, “including” any component will be understood to imply the inclusion of other components rather than the exclusion of other components.

The term “free-standing catalyst layer” as used herein may refer to a catalyst layer that may exist in an independent standing form without a separate support or substrate.

The catalyst layer satisfying mechanical properties according to the present disclosure may be manufactured using an electrode slurry satisfying specific mechanical properties. The electrode slurry according to the present disclosure may be manufactured by various methods by mixing a catalyst and an ionomer with each other in a specific ratio.

A membrane-electrode assembly according to the present disclosure includes a catalyst layer satisfying mechanical properties, and has a flexural modulus of 450 to 1,000 MPa, and a flexural strength of 12 to 80 MPa.

The flexural modulus is a mechanical property for evaluating stiffness or a bending-resistant degree of the membrane-electrode assembly, and may be evaluated when a load is applied to an elongated material in a vertical direction. For example, the flexural modulus of the membrane-electrode assembly is calculated by measuring a slope of a straight line of a stress-strain curve (S-S Curve), and is a value obtained by dividing stress divided by a strain corresponding to the stress. Ideally, the flexural modulus of the membrane-electrode assembly is equal to the Young's modulus, but in practice, the higher the flexural modulus, the more difficult it is to bend the membrane-electrode assembly. Conversely, the lower the flexural modulus, the more easily the membrane-electrode assembly may be bent due to an applied force. The flexural modulus may be measured, for example, using an Instron 5966 instrument in a compression mode, and may be obtained by repeatedly applying a load (10 N) approximately times using a probe and a holder for a puncture test. Alternatively, the flexural modulus may be obtained by measuring a deformation rate at a loading speed of 5.0 mN/min in an indentation manner using a nanoindenter. The flexural modulus of the membrane-electrode assembly according to the present disclosure may be 450 to 1,000 MPa, specifically 500 to 850 MPa, and more specifically 600 to 700 MPa. When the flexural modulus is less than 450 MPa, elasticity of the membrane-electrode assembly may be low, so that mechanical durability of the membrane-electrode assembly may be reduced, and when the flexural modulus exceeds 1,000 MPa, elasticity of the membrane-electrode assembly may be excessively high, and the membrane-electrode assembly may have a relatively high ionomer content to become sensitive to moisture, so that processability may be reduced. Additionally, the flexural modulus corresponds to the mechanical durability of the membrane-electrode assembly, and the membrane-electrode assembly having the flexural modulus within the range suggested in the present disclosure exhibits higher mechanical durability than a membrane-electrode assembly having a flexural modulus of less than 450 MPa.

The flexural strength may be defined as vertical stress generated in the membrane-electrode assembly due to the bending of the membrane-electrode assembly in a bending test for the membrane-electrode assembly. The flexural strength may be obtained by measuring a maximum force applied until a sample is permanently deformed using, for example, the Instron 5966 instrument, and may be expressed as an average value of repeated measurements performed ten times or more. The flexural strength of the membrane-electrode assembly according to the present disclosure may be 12 to 80 MPa, specifically 13 to 50 MPa, and more specifically 15 to 20 MPa. When the flexural strength is less than 12 MPa, mechanical properties of the membrane-electrode assembly may be poor, so that the membrane-electrode assembly may be easily deformed even by a small external force, and it is thus difficult to process the membrane-electrode assembly, and when the flexural strength exceeds 80 MPa, flexibility of the membrane-electrode assembly may be low, so that processability may be reduced when a sub-gasket and a gas diffusion layer (GDL) are attached thereto in the future.

Meanwhile, the Young's modulus of the membrane-electrode assembly according to the present disclosure may be 650 to 1,600 MPa.

The Young's modulus is a coefficient indicating how a relative length of the membrane-electrode assembly having elasticity changes depending on stress. For example, the Young's modulus may be obtained by stretching a specimen at a stretch speed of 50 mm/min and measuring a slope in a strain section of 0.25 to 1%, using the Instron 5966 instrument, and may be expressed as an average value of repeated measurements performed ten times or more. The Young's modulus of the membrane-electrode assembly according to the present disclosure may be 650 to 1,600 MPa, specifically 800 to 1,300 MPa, and more specifically 900 to 1,000 MPa. When the Young's modulus of the membrane-electrode assembly is less than 650 MPa, elasticity of the membrane-electrode assembly may be low, so that the membrane-electrode assembly may be easily torn and deformed even by a small external force, and it is thus difficult to process the membrane-electrode assembly, and when the Young's modulus exceeds 1,600 MPa, elasticity of the membrane-electrode assembly may be high, so that processability may be reduced when the sub-gasket and the gas diffusion layer (GDL) are attached thereto in the future.

The tensile strength of the membrane-electrode assembly according to the present disclosure may be 35 to 90 MPa.

The tensile strength refers to maximum stress until the membrane-electrode assembly is broken by a tensile load. For example, the tensile strength is obtained by dividing a maximum tensile load (Wₘₐₓ) by an original cross-sectional area (A₀) of the specimen. The tensile strength is broadly divided into a tensile strength at a yield point and a tensile strength at a break point, and the yield point refers to a force at the highest point that a material receives, and the break point refers to a force at a point in time when the material is broken. The tensile strength of the membrane-electrode assembly according to the present disclosure refers to the tensile strength at the break point of the specimen. The tensile strength may be obtained by preparing a specimen of the membrane-electrode assembly and stretching the specimen at a stretch speed of 50 mm/min and measuring a maximum stress value, using a tensile strength tester such as the Instron 5966 instrument. The tensile strength of the membrane-electrode assembly according to the present disclosure may be 35 to 90 MPa, specifically 45 to 80 MPa, and more specifically 60 to 70 MPa. When the tensile strength is less than 35 MPa, the membrane-electrode assembly may be excessively flexible to be easily torn and deformed even by a small external force, so that mechanical properties of the membrane-electrode assembly may be poor, and when the tensile strength exceeds 90 MPa, the membrane-electrode assembly may be excessively hard, so that processability may be reduced when the sub-gasket and the gas diffusion layer (GDL) are attached thereto in the future.

In addition, the indentation hardness of the membrane-electrode assembly according to the present disclosure may be 2.0 to 9.0 MPa.

The indentation hardness is a strength expressed according to an indentation method, and there are various methods for measuring a hardness, but a hardness expression method by the indentation hardness has been widely used in countries around the world at present. The hardness expression method by the indentation hardness is a method for expressing a hardness by a size of indentation generated in a specimen after pushing an indenter (a steel ball, a diamond horn, etc.) of a tester into the specimen, and the hardness obtained by this method is called an indentation hardness. The indentation hardness may be obtained by measuring a maximum force for surface permanent deformation in an indentation manner using, for example, a nanoindenter, and may be expressed as an average value of repeated measurements performed ten times or more. The indentation hardness of the membrane-electrode assembly according to the present disclosure may be 2.0 to 9.0 MPa, specifically 2.5 to 7.0 MPa, and more specifically 3.0 to 5.0 MPa. When the indentation hardness is less than 2.0 MPa, the membrane-electrode assembly may be excessively flexible and the structure of the catalyst layer may be weak, so that mechanical properties of the membrane-electrode assembly may be poor, and when the indentation hardness exceeds 9.0 MPa, the membrane-electrode assembly may become brittle, and attachment of the sub-gasket and the gas diffusion layer (GDL) and harmony with the sub-gasket and the gas diffusion layer (GDL) may be difficult due to a hard surface of the catalyst layer.

In addition, the catalyst layer according to the present disclosure may include an interfacial bonding layer (IBL).

Such an interfacial bonding layer may allow the membrane-electrode assembly to have low hydrogen permeability without a reduction in hydrogen ion conductivity, may improve durability of the membrane-electrode assembly by improving bondability of an interface between the catalyst layer and an electrolyte membrane, and may improve performance and durability of the membrane-electrode assembly under high temperature/low humidity conditions.

In this case, the thickness of the interfacial bonding layer may be 0.1 μm to 1.5 μm. When the thickness of the interfacial bonding layer is less than 0.1 μm, the catalyst layer and the membrane-electrode assembly including the catalyst layer may not satisfy mechanical properties to be achieved in the present disclosure, so that durability of the membrane-electrode assembly may be reduced, and when the thickness of the interfacial bonding layer exceeds 1.5 μm, elasticity of the catalyst layer and the membrane-electrode assembly including the catalyst layer may be excessively high or flexibility of the catalyst layer and the membrane-electrode assembly including the catalyst layer may be low, so that processability may be reduced, and an ion transfer path may be long, so that performance may be reduced.

The membrane-electrode assembly according to the present disclosure may be manufactured by bonding the catalyst layer satisfying mechanical properties and the electrolyte membrane to each other. In this case, the electrolyte membrane may be a fluorine-based reinforced membrane generally used in a fuel cell, but is not limited thereto.

Meanwhile, a free-standing catalyst layer according to the present disclosure has a flexural modulus of 50 to 400 MPa and a flexural strength of 0.3 to 10 MPa.

The free-standing catalyst layer may be manufactured by coating and drying the catalyst layer satisfying the mechanical properties described above on a substrate such as a glass substrate and then separating the catalyst layer from the substrate.

The flexural modulus of the free-standing catalyst layer may be 50 to 400 MPa, specifically 150 to 300 MPa, and more specifically 190 to 240 MPa. When the flexural modulus is less than 50 MPa, elasticity of the catalyst layer may be low, and when the flexural modulus exceeds 400 MPa, elasticity of the catalyst layer may be excessively high, so that processability such as bonding strength with the electrolyte membrane may be reduced.

In addition, the flexural strength of the free-standing catalyst layer according to the present disclosure may be 0.3 to 10 MPa, specifically 1 to 5 MPa, and more specifically 2 to 3 MPa. When the flexural strength is less than 0.3 MPa, mechanical properties of the catalyst layer may be poor, so that the catalyst layer may be easily bent, and when the flexural strength exceeds 10 MPa, flexibility of the catalyst layer may be low, so that processability such as bonding strength with the electrolyte membrane may be reduced.

The Young's modulus of the free-standing catalyst layer may be 150 to 500 MPa, specifically 200 to 400 MPa, and more specifically 300 to 320 MPa. When the Young's modulus is less than 150 MPa, elasticity of the catalyst layer may be low, so that the catalyst layer may be easily torn and broken, and when the Young's modulus exceeds 500 MPa, elasticity of the catalyst layer may be excessively high, so that processability such as bonding strength with the electrolyte membrane may be reduced.

In addition, the tensile strength of the free-standing catalyst layer according to the present disclosure may be 1 to 30 MPa, specifically 1 to 10 MPa, and more specifically 2 to 5 MPa. When the tensile strength is less than 1 MPa, the catalyst layer may be excessively flexible, so that mechanical properties of the catalyst layer may be poor, and when the tensile strength exceeds 30 MPa, the catalyst layer may be excessively hard, such that processability such as bonding strength with the electrolyte membrane may be reduced.

Furthermore, the indentation hardness of the free-standing catalyst layer according to the present disclosure may be 0.05 to 3.0 MPa, specifically 0.1 to 3.0 MPa, and more specifically 1.0 to 3.0 MPa. When the indentation hardness is less than 0.05 MPa, the catalyst layer may be excessively flexible, so that mechanical properties of the catalyst layer may be poor, and when the indentation hardness exceeds 3.0 MPa, the catalyst layer may become brittle, and bonding strength with the electrolyte membrane may be reduced and attachment of the sub-gasket and the gas diffusion layer (GDL) and harmony with the sub-gasket and the gas diffusion layer (GDL) may be difficult due to a hard surface of the catalyst layer.

In addition, the density of the free-standing catalyst layer according to the present disclosure may be 0.1 to 2.0 g/cm³.

The density of the free-standing catalyst layer may be obtained by, for example, measuring a weight after coating the catalyst layer on an area of 25 cm² and a weight after removing the catalyst layer with a tape to obtain a weight of the coating layer and obtaining a volume from an average thickness of the catalyst layer using a scanning electron microscope (SEM), and may be expressed as an average value of repeated measurements performed ten times or more. The density of the free-standing catalyst layer according to the present disclosure is 0.1 to 2.0 g/cm³, specifically 0.5 to 1.5 g/cm³, and more specifically 0.9 to 1.0 g/cm³. When the density of the free-standing catalyst layer is less than 0.1 g/cm³, the catalyst layer may be excessively flexible and the volume may be great, so that mechanical properties of the catalyst layer may be poor, and when the density of the free-standing catalyst layer exceeds 2.0 g/cm³, the structure of the catalyst layer may be dense, so that material transfer may not be easy, and accordingly, performance may be reduced.

Meanwhile, the free-standing catalyst layer according to the present disclosure may be manufactured by coating an electrode slurry on a substrate having a release property. The free-standing catalyst layer detached from the substrate is in a free-standing state in which a support for supporting a material is not required. Here, the term “free-standing” refers to characteristics that any member may exist in an independently standing form without an additional separate support or substrate. For example, the free-standing catalyst layer may be in a film form.

The free-standing catalyst layer in this state may have excellent flexibility and exist independently to be easily handled. In order to form the free-standing catalyst layer according to the present disclosure, it is preferable that the substrate has a release property so that the film may be easily peeled from the substrate after being formed on the substrate.

That is, according to another embodiment of the present disclosure, a method for manufacturing the free-standing catalyst layer includes: a first step of preparing an electrode slurry including a catalyst and an ionomer; a second step of forming an electrode slurry coating layer by coating the electrode slurry on a substrate; and a third step of separating a free-standing catalyst layer from the substrate by drying the electrode slurry coating layer, immersing the dried electrode slurry coating layer in water at room temperature, and then leaving the immersed electrode slurry coating layer. Furthermore, the catalyst layer separated as described above may be additionally dried on another substrate.

For example, in the method for manufacturing a free-standing catalyst layer, the free-standing catalyst layer may be manufactured by applying an electrode slurry to a substrate and then performing heat treatment to form a film. The heat treatment may be performed at 60 °C to 200 °C, and specifically, 80 °C to 180 °C. When the heat treatment is performed at a temperature lower than 80 °C, structural stability of the film may be reduced, so that it may be difficult to manufacture the free-standing catalyst layer in a free-standing form.

A method for manufacturing a membrane-electrode assembly according to the present disclosure includes: a first step of preparing an electrode slurry including a catalyst and an ionomer; a second step of forming an electrode slurry coating layer by coating the electrode slurry on a substrate; a third step of forming a catalyst layer satisfying mechanical properties by drying the electrode slurry coating layer; and a fourth step of bonding the catalyst layer satisfying the mechanical properties and an electrolyte membrane to each other.

Here, the substrate may be a release film or a glass plate, but is not limited thereto, and any substrate having a release property may be used as the substrate without limitation.

In the method for manufacturing a membrane-electrode assembly according to the present disclosure, for example, an electrode including an interfacial bonding layer (IBL) may be manufactured by mixing a catalyst and an ionomer with each other so as to have a specific composition ratio to manufacture an electrode slurry, coating the electrode slurry on a release film and then drying the electrode slurry to form a catalyst layer satisfying mechanical properties, and then applying an ionomer solution onto the catalyst layer satisfying the mechanical properties in a spray manner. A catalyst-coated membrane (CCM) or a membrane-electrode assembly (MEA) may be manufactured by transferring or bonding the electrode including the IBL manufactured as described above to an electrolyte membrane using an isostatic decal laminator. In this case, the electrolyte membrane may be a fluorine-based reinforced membrane generally usable in the fuel cell field.

In the catalyst layer satisfying the mechanical properties according to the present disclosure, the type of catalyst carrier, the type and loading amount of metal catalyst, the type and content of ionomer, an additive, a solid content, the structure of the catalyst layer, and the like, may be appropriately adjusted according to required mechanical properties.

The catalyst carrier may be selected from the group consisting of silica, alumina, zirconia, and titania, but is not limited thereto.

The ionomer is preferably any one or a mixture of two selected from a fluorine-based ionomer and a hydrocarbon-based ionomer. As the fluorine-based ionomer, one or more selected from Nafion, Flemion, and Aciplex may be used. In addition, the hydrocarbon-based ionomer may be selected from a homo copolymer, an alternating copolymer, a random copolymer, a block copolymer, a multiblock copolymer, a graft copolymer, or mixtures thereof, including at least one hydrocarbon selected from the group consisting of sulfonated imide, sulfonated arylethersulfone, sulfonated etheretherketone, sulfonated benzimidazole, sulfonated sulfone, sulfonated styrene, sulfonated phosphazene, sulfonated etherethersulfone, sulfonated ethersulfone, sulfonated etherbenzimidazole, sulfonated aryleneetherketone, sulfonated etherketone, sulfonated imidazole, sulfonated etherketoneketone, an aryletherbenzimidazole, and combinations thereof.

As the catalyst, any catalyst that may be used as a catalyst for a hydrogen oxidation reaction or an oxygen reduction reaction may be used, but a platinum-based metal is preferably used. The platinum-based metal may include one selected from the group consisting of platinum (Pt), palladium (Pd), ruthenium (Ru), iridium (Ir), osmium (Os), and a platinum-M alloy (here, M is one or more or selected from the group consisting of palladium (Pd), ruthenium (Ru), iridium (Ir), osmium (Os), gallium (Ga), titanium (Ti), vanadium (V), chromium (Cr), manganese (Mn), iron (Fe), cobalt (Co), nickel (Ni), copper (Cu), silver (Ag), gold (Au), zinc (Zn), tin (Sn), molybdenum (Mo), tungsten (W), lanthanum (La), and rhodium (Rh), and combinations thereof, and more preferably, may be a combination of two or more metals selected from the group consisting of the platinum-based catalyst metals, but is not limited thereto, and any platinum-based catalyst metal usable in the present technical field may be used without limitation.

### (Example 1) Configuration of Catalyst Layer and Manufacture of Membrane-Electrode Assembly

### Manufacture of Electrode Slurry

A cathode slurry having a composition of I/C=1.1 was manufactured using a 50% Pt—Co/C catalyst (available from TANAKA PRECIOUS METAL GROUP Co., Ltd) and a PFSA ionomer (available from 3M Company). An anode slurry having a composition in which a weight ratio of ionomer to catalyst particles is 1.0 (I/C=1.0) was manufactured using 50% Pt—Ru/C catalyst particles (available from TANAKA PRECIOUS METAL GROUP Co., Ltd) and a PFSA ionomer (available from 3M Company).

### Step of Forming Sub-Catalyst Layer

Sub-catalyst layers were manufactured by coating the manufactured electrode slurries on release films in a cathode loading amount of 0.4 mg/cm² and an anode loading amount of 0.1 mg/cm², and then drying the coated electrode slurries at 90 °C for 180 minutes.

### Step of Forming Interfacial Bonding Layer and Step of Manufacturing Catalyst Layer

An interfacial bonding layer (IBL) having a thickness of 0.1 to 1.5 μm (average thickness of 0.6 μm) was formed by applying a PFSA ionomer solution (total solid content: 5 wt % and equivalent: 3 to 10) on one surface of each of the manufactured sub-catalyst layers in a spray manner and then drying the PFSA ionomer solution at 120 °C for one minute. As a result, a catalyst layer including the sub-catalyst layer and the interfacial bonding layer was manufactured.

### Step of Manufacturing Membrane-Electrode Assembly

A membrane-electrode assembly was manufactured by locating the interfacial bonding layer of the manufactured catalyst layer so as to be in contact with an electrolyte membrane and then bonding the catalyst layer to the electrolyte membrane using an isostatic decal laminator. As the electrolyte membrane, a fluorine-based reinforced membrane in which a porous support (PTFE support, porosity: 70%, and thickness: 5 μm) is impregnated with a PFSA ionomer solution was used.

### (Example 2) Configuration of Catalyst Layer and Manufacture of Membrane-Electrode Assembly (Type of Catalyst is Different)

A membrane-electrode assembly was manufactured in the same manner as in Example 1, except that a 50% Pt/C catalyst (available from TANAKA PRECIOUS METAL GROUP Co., Ltd) was used when a cathode slurry was manufactured.

### (Example 3) Configuration of Catalyst Layer and Manufacture of Membrane-Electrode Assembly (Type of Ionomer is Different)

A membrane-electrode assembly was manufactured in the same manner as in Example 1, except that a Nafion PFSA ionomer (available from Chemours Company) was used when a cathode slurry was manufactured.

### (Example 4) Configuration of Catalyst Layer and Manufacture of Membrane-Electrode Assembly (Ratio of I/C is Different)

A membrane-electrode assembly was manufactured in the same manner as in Example 1, except that a composition with I/C=0.95 was used when a cathode slurry was manufactured.

### (Example 5) Configuration of Catalyst Layer and Manufacture of Membrane-Electrode Assembly (Loading Amount is Different)

A membrane-electrode assembly was manufactured in the same manner as in Example 1, except that an electrode was manufactured by manufacturing a cathode slurry and coating and then drying the manufactured cathode slurry on a release film in a cathode loading amount of 0.3 mg/cm².

### (Example 6) Configuration of Catalyst Layer and Manufacture of Membrane-Electrode Assembly (Bonding Method is Different)

A membrane-electrode assembly was manufactured in the same manner as in Example 1, except that the membrane-electrode assembly was manufactured by bonding the electrode including the IBL to the electrolyte membrane using a hydraulic hot & cold press.

### (Example 1-1) Manufacturing of Free-Standing Catalyst Layer

The cathode slurry manufactured in Example 1 was coated and then dried on a glass plate. An IBL having a thickness of 0.1 to 1.5 μm (average thickness: 0.6 μm) was manufactured by applying an ionomer solution to the dried electrode. A free-standing catalyst layer was manufactured by immersing and leaving the manufactured electrode in water at room temperature to separate the electrode and drying the separated electrode on another glass plate.

### (Comparative Example 1) Configuration of Catalyst Layer and Manufacture of Membrane-Electrode Assembly (Thickness of IBL is Different)

A membrane-electrode assembly was manufactured in the same manner as in Example 1, except that an IBL having an average thickness of 0.06 μm was manufactured by applying an ionomer solution to the manufactured electrode in a spray manner.

### (Comparative Example 1-1) Manufacturing of Free-Standing Catalyst Layer (Thickness of IBL is Different)

The cathode slurry manufactured in Example 1 was coated and then dried on a glass plate. An IBL having an average thickness of 0.06 μm was manufactured by applying an ionomer solution to the dried electrode. A free-standing catalyst layer was manufactured by immersing and leaving the manufactured electrode in water at room temperature to separate the electrode and drying the separated electrode on another glass plate.

### (Comparative Example 2) Configuration of Catalyst Layer and Manufacture of Membrane-Electrode Assembly

A membrane-electrode assembly was manufactured in the same manner in Example 1, except that a process of manufacturing an interfacial bonding layer (IBL) by applying an ionomer solution to the electrode manufactured in Example 1 in a spray manner was excluded.

### (Comparative Example 2-1) Manufacturing of Free-Standing Catalyst Layer

The cathode slurry manufactured in Example 1 was coated and then dried on a glass plate. A free-standing catalyst layer was manufactured in the same manner in Example 1, except that a process of manufacturing an IBL by applying an ionomer solution to the dried electrode was excluded.

### (Experimental Example 1) Preparation of Young's Modulus and Tensile Strength Specimens

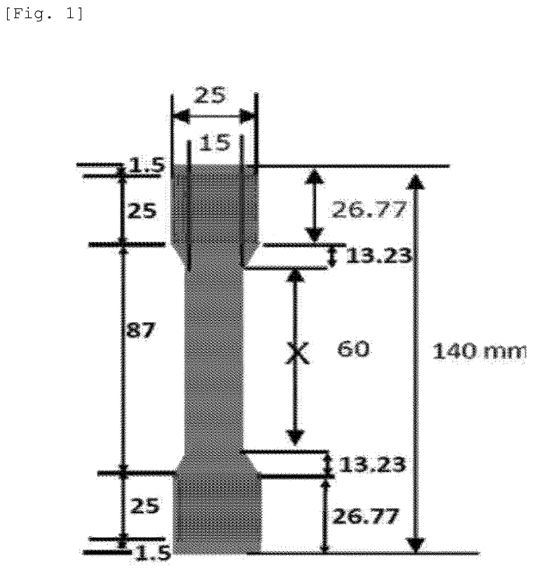

Specimens were manufactured by cutting the free-standing catalyst layer to a size of 5×50 mm. In addition, a membrane-electrode assembly was manufactured in a dog bone shape as shown in FIG. 1.

### (Experimental Example 2) Measurement of Young's Modulus

Specimens were stretched at a stretch speed of 50 mm/min and slopes in a strain section of 0.25 to 1% were measured, using the Instron 5966 instrument. Average values of repeated measurements performed ten times or more were obtained, and the measurement results are shown in Table 1.

TABLE 1

| | | | | | | | | | Free-standing | | |
|---|---|---|---|---|---|---|---|---|---|---|---|
| | Membrane-electrode assembly | | | | | | | | catalyst layer | | |
| | | | | | | | Compar- | Compar- | | Compar- | Compar- |
| | | | | | | | ative | ative | | ative | ative |
| | Exam- | Exam- | Exam- | Exam- | Exam- | Exam- | Exam- | Exam- | Exam- | Exam- | Exam- |
| Sample | ple 1 | ple 2 | ple 3 | ple 4 | ple 5 | ple 6 | ple 1 | ple 2 | ple 1-1 | ple 1-1 | ple 2-1 |
| Young' s | 980 | 980 | 930 | 910 | 910 | 900 | 610 | 560 | 310 | 140 | 90 |
| modulus | | | | | | | | | | | |
| (MPa) | | | | | | | | | | | |

### (Experimental Example 3) Measurement of Tensile Strength

Specimens were stretched at a stretch speed of 50 mm/min and maximum stress values were measured, using the Instron 5966 instrument. Average values of repeated measurements performed ten times or more were obtained, and measurement results are shown in Table 2.

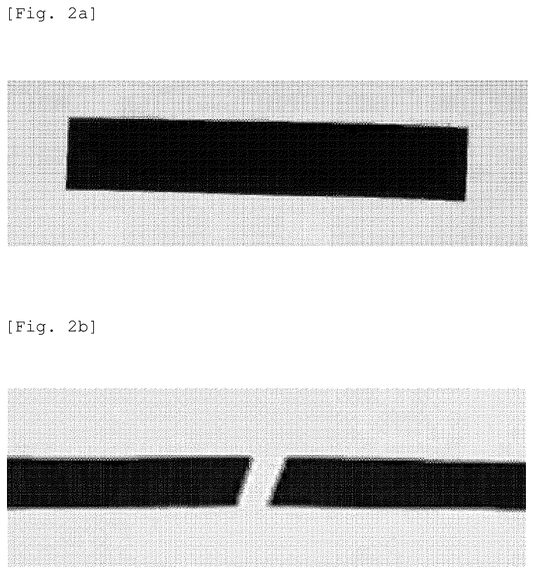

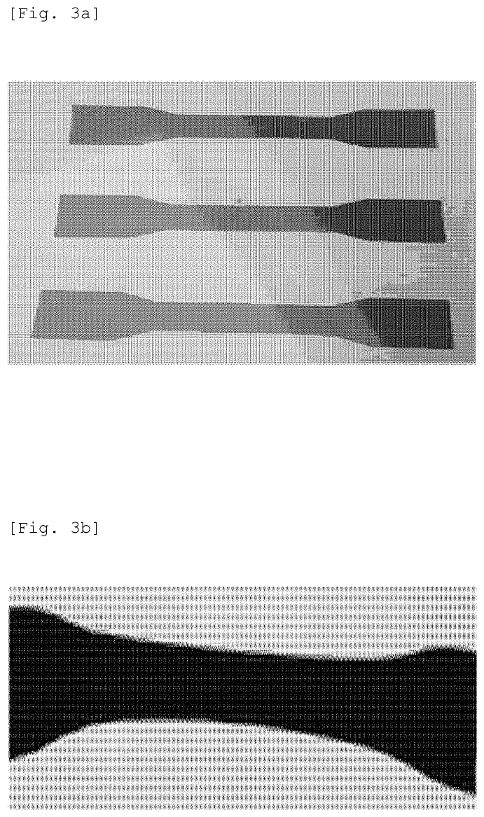

For reference, FIG. 2a is an image of free-standing catalyst layers according to Experimental Examples 2 and 3 of the present disclosure before the Young's modulus and the tensile strength are measured, and FIG. 2b is an image of the free-standing catalyst layers according to Experimental Examples 2 and 3 of the present disclosure after the Young's modulus and the tensile strength are measured. In addition, FIG. 3a is an image of membrane-electrode assemblies according to Experimental Examples 2 and 3 of the present disclosure before the Young's modulus and the tensile strength are measured, and FIG. 3b is an image of the membrane-electrode assemblies according to Experimental Examples 2 and 3 of the present disclosure after the Young's modulus and the tensile strength are measured.

TABLE 2

| | | | | | | | | | Free-standing | | |
|---|---|---|---|---|---|---|---|---|---|---|---|
| | Membrane-electrode assembly | | | | | | | | catalyst layer | | |
| | | | | | | | Compar- | Compar- | | Compar- | Compar- |
| | | | | | | | ative | ative | | ative | ative |
| | Exam- | Exam- | Exam- | Exam- | Exam- | Exam- | Exam- | Exam- | Exam- | Exam- | Exam- |
| Sample | ple 1 | ple 2 | ple 3 | ple 4 | ple 5 | ple 6 | ple 1 | ple 2 | ple 1-1 | ple 1-1 | ple 2-1 |
| Tensile | 68 | 68 | 64 | 60 | 60 | 56 | 33 | 28 | 3.3 | 0.9 | 0.6 |
| strength | | | | | | | | | | | |
| (MPa) | | | | | | | | | | | |

### (Experimental Example 4) Preparation of Flexural Modulus & Flexural Strength Specimens

Specimens were manufactured by cutting the free-standing catalyst layer and the membrane-electrode assembly to a size of 50×50 mm.

### (Experimental Example 5) Measurement of Flexural Modulus

As a first method, the Instron 5966 instrument was used in a compression mode. A load (10 N) was repeatedly (20 times) applied to the specimens using a probe and a holder for a puncture test. As another method, deformation rates were measured at a loading rate of 5.0 mN/min in an indentation manner using the nanoindenter, and measurement results are shown in Table 3.

TABLE 3

| | | | | | | | | | Free-standing | | |
|---|---|---|---|---|---|---|---|---|---|---|---|
| | Membrane-electrode assembly | | | | | | | | catalyst layer | | |
| | | | | | | | Compar- | Compar- | | Compar- | Compar- |
| | | | | | | | ative | ative | | ative | ative |
| | Exam- | Exam- | Exam- | Exam- | Exam- | Exam- | Exam- | Exam- | Exam- | Exam- | Exam- |
| Sample | ple 1 | ple 2 | ple 3 | ple 4 | ple 5 | ple 6 | ple 1 | ple 2 | ple 1-1 | ple 1-1 | ple 2-1 |
| Flexural | 650 | 650 | 630 | 600 | 600 | 580 | 420 | 380 | 200 | 48 | 40 |
| modulus | | | | | | | | | | | |
| (Instron) | | | | | | | | | | | |
| (MPa) | | | | | | | | | | | |
| Flexural | 680 | 680 | 650 | 620 | 620 | 590 | 430 | 390 | 230 | 48 | 40 |
| modulus | | | | | | | | | | | |
| (Nanoindenter) | | | | | | | | | | | |
| (MPa) | | | | | | | | | | | |

### (Experimental Example 6) Measurement of Flexural Strength

Maximum forces applied until samples were permanently deformed were measured using the Instron 5966 instrument. Average values of repeated measurements performed ten times or more were obtained, and measurement results are shown in Table 4.

TABLE 4

| | | | | | | | | | Free-standing | | |
|---|---|---|---|---|---|---|---|---|---|---|---|
| | Membrane-electrode assembly | | | | | | | | catalyst layer | | |
| | | | | | | | Compar- | Compar- | | Compar- | Compar- |
| | | | | | | | ative | ative | | ative | ative |
| | Exam- | Exam- | Exam- | Exam- | Exam- | Exam- | Exam- | Exam- | Exam- | Exam- | Exam- |
| Sample | ple 1 | ple 2 | ple 3 | ple 4 | ple 5 | ple 6 | ple 1 | ple 2 | ple 1-1 | ple 1-1 | ple 2-1 |
| Flexural | 19 | 19 | 16 | 14 | 14 | 13 | 11 | 9 | 2.7 | 0.2 | 0.1 |
| strength | | | | | | | | | | | |
| (MPa) | | | | | | | | | | | |

### (Experimental Example 7) Measurement of Indentation Hardness

Maximum forces for surface permanent deformation were measured in an indentation manner using the nanoindenter. Average values of repeated measurements performed ten times or more were obtained, and measurement results are shown in in Table 5.

TABLE 5

| | | | | | | | | | Free-standing | | |
|---|---|---|---|---|---|---|---|---|---|---|---|
| | Membrane-electrode assembly | | | | | | | | catalyst layer | | |
| | | | | | | | Compar- | Compar- | | Compar- | Compar- |
| | | | | | | | ative | ative | | ative | ative |
| | Exam- | Exam- | Exam- | Exam- | Exam- | Exam- | Exam- | Exam- | Exam- | Exam- | Exam- |
| Sample | ple 1 | ple 2 | ple 3 | ple 4 | ple 5 | ple 6 | ple 1 | ple 2 | ple 1-1 | ple 1-1 | ple 2-1 |
| Hardness | 3.9 | 3.9 | 3.8 | 3.7 | 3.7 | 3.5 | 3.5 | 3.5 | 2.1 | 1.3 | 1.8 |
| (MPa) | | | | | | | | | | | |

### (Experimental Example 8) Measurement of Density

Weights after electrodes are coated on an area of 25 cm² and weights after the electrodes were removed with tapes were measured. Densities were calculated from an average thickness of catalyst layers using an SEM and weights per volume. Average values of repeated measurements performed ten times or more were obtained, and measurement results are shown in Table 6.

TABLE 6

| | Cathode | | | |
|---|---|---|---|---|
| | | Comparative | Comparative | |
| Sample | Example 1-1 | Example 1-1 | Example 2-1 | Anode |
| Density | 0.933 | 0.938 | 0.955 | 0.952 |
| (g/cm³) | | | | |

### (Experimental Example 9) Evaluation of Physical (Mechanical) Durability

Physical durability of each of the membrane-electrode assemblies according the Examples and the Reference Examples was evaluated based on a Wet-dry durability evaluation protocol of the Department of Energy (DOE). Specifically, in order to evaluate the physical durability of the membrane-electrode assemblies, hydrogen crossover (H₂ crossover) was measured after performing 20,000 wet-dry cycles, and measurement results are shown in in Table 7. The membrane-electrode assemblies according to the Examples exhibited very stable physical durability satisfying a DOE standard (H₂ crossover≤15 mA/cm²@wet-dry 20,000 cycles).

TABLE 7

| | | | | | | | | Compar- | Compar- |
|---|---|---|---|---|---|---|---|---|---|
| | | | | | | | | ative | ative |
| | | Exam- | Exam- | Exam- | Exam- | Exam- | Exam- | Exam- | Exam- |
| Sample | | ple 1 | ple 2 | ple 3 | ple 4 | ple 5 | ple 6 | ple 1 | ple 2 |
| H2 | Before | 3.6 | 3.6 | 3.8 | 3.7 | 3.7 | 3.8 | 3.7 | 3.6 |
| cross- | W/D | | | | | | | | |
| over@0.2 V | After | 3.8 | 3.8 | 4.2 | 3.9 | 3.9 | 4.0 | 8.7 | 9.5 |
| (mA/cm²) | W/D | | | | | | | | |

It might be confirmed that catalyst layers and membrane-electrode assemblies satisfied the following parameters even when measurements were performed by other similar methods as well as the method according to the Experimental Examples. Young's modulus: 150 to 500 MPa (free standing), 650 to 1600 MPa (MEA)
Tensile strength: 1 to 30 MPa (free standing), 35 to 90 MPa (MEA)
Flexural modulus: 50 to 400 MPa (free standing), 450 to 1,000 MPa (MEA)
Flexural strength: 0.3 to 10 MPa (free standing), 12 to 80 MPa (MEA)
Indentation hardness: 0.05 to 3.0 MPa (free standing), 2.0 to 9.0 MPa (MEA)
Density: 0.1 to 2.0 g/cm³

The present disclosure is not limited to the above-described embodiments, but may be implemented in various different forms, and those skilled in the art to which the present disclosure pertains may understand that the present disclosure may be implemented in other specific forms without changing the technical spirit or essential features of the present disclosure. Therefore, it is to be understood that the embodiments described above are illustrative rather than being restrictive in all aspects.

1. A catalyst layer having a flexural modulus of 50 to 400 MPa and a flexural strength of 0.3 to 10 MPa.

2. The catalyst layer of claim 1, wherein the catalyst layer is a free-standing catalyst layer.

3. The catalyst layer of claim 2, wherein a Young's modulus of the free-standing catalyst layer is 150 to 500 MPa.

4. The catalyst layer of claim 2, wherein a tensile strength of the free-standing catalyst layer is 1 to 30 MPa.

5. The catalyst layer of claim 2, wherein an indentation hardness of the free-standing catalyst layer is 0.05 to 3.0 MPa.

6. The catalyst layer of claim 2, wherein a density of the free-standing catalyst layer is 0.1 to 2.0 g/cm³.

7. The catalyst layer of claim 2, wherein the free-standing catalyst layer includes:
a sub-catalyst layer; and
an interfacial bonding layer (IBL) disposed on at least one surface of the sub-catalyst layer.

8. The catalyst layer of claim 7, wherein a thickness of the interfacial bonding layer is 0.1 to 1.5 μm.

9. A method for manufacturing a catalyst layer, comprising:
a first step of preparing an electrode slurry including a catalyst and an ionomer;
a second step of forming a sub-catalyst layer by coating and then drying the electrode slurry on a substrate;
a third step of forming an interfacial bonding layer by coating and then drying an ionomer solution on one surface of the sub-catalyst layer; and
a fourth step of separating the catalyst layer from the substrate by immersing and then leaving a resultant of the third step in water.

10. A membrane-electrode assembly comprising the catalyst layer of claim 1, and having a flexural modulus of 450 to 1,000 MPa and a flexural strength of 12 to 80 MPa.

11. The membrane-electrode assembly of claim 10, having a Young's modulus of 650 to 1,600 MPa.

12. The membrane-electrode assembly of claim 10, having a tensile strength of 35 to 90 MPa.

13. The membrane-electrode assembly of claim 10, having an indentation hardness of 2.0 to 9.0 MPa.

14. A method for manufacturing a membrane-electrode assembly, comprising a step of bonding the catalyst layer of claim 1 and an electrolyte membrane to each other.
